(19) United States
(12) Patent Application Publication
(10) Pub. No.: US 2015/0174736 A1
(43) Pub. Date: Jun. 25, 2015

(54) Composite Backing Material Layer And Method Of Forming Same

(71) Applicants: Saint-Gobain Abrasives, Inc., Worcester, MA (US); Saint-Gobain Abrasifs, Conflans-Sainte-Honorine (FR)

(72) Inventors: Adiseshaiah K. SATHYANARAYANAIAH, Chennai (IN); Muthukrishnan SHARMILA, CHENNAI (IN)

(21) Appl. No.: 14/567,821

(22) Filed: Dec. 11, 2014

(30) Foreign Application Priority Data
Dec. 20, 2013 (IN) 5964/CHE/2013

(51) Int. Cl. B24D 11/02; B32B 37/18; B32B 5/02; B32B 27/12; B32B 27/30; B32B 27/42; B32B 7/12; B32B 9/02; B32B 37/12; B32B 27/32

(52) U.S. Cl. CPC B24D 11/02; B32B 37/1284; B32B 37/18; B32B 5/022; B32B 27/32; B32B 27/304; B32B 27/42; B32B 5/024; B32B 7/12; B32B 9/02; B32B 27/12; B32B 2262/06

(57) ABSTRACT

A composite backing material and coated abrasive article including same, wherein the composite backing material includes a first flexible backing material layer; a natural fiber layer; and a second flexible backing material layer, wherein the natural fiber layer is disposed on the first flexible backing material layer and the second backing material layer is disposed on the natural fiber layer.

### CROSS-REFERENCE TO RELATED APPLICATION

The application claims priority under 35 U.S.C. §119(a)-(d) to, and incorporates herein by reference in its entirety for all purposes, Indian application 5964/CHE/2013, filed Dec. 20, 2013, entitled “Composite Backing Material Layer and Method of Forming Same”, to Adiseshaiah K. SATHYANARAYANAIAH et al., which application is incorporated by reference herein in its entirety.

### FIELD OF THE DISCLOSURE

The following is generally directed to articles and methods related to composite backing materials and abrasive articles that include such composite backing materials.

### BACKGROUND

Abrasive articles have been used to abrade and finish work-piece surfaces. Applications suitable for using abrasive articles include high stock removal from workpieces such as wood and metal, to fine polishing of ophthalmic lenses, fiber optics and computer read-write heads. In general, abrasive articles comprise a plurality of abrasive particles bonded either together (e.g., a bonded abrasive or grinding wheel) or to a backing (e.g., a coated abrasive article). For a coated abrasive article, there is typically a single layer, or sometimes a plurality of layers, of abrasive particles bonded to the backing. The abrasive particles can be bonded to the backing with a “make” coat and “size” coat, or as a slurry coat. Further, a supersize coat can be applied on the make coat or size coat to help extend the life of the abrasive particles.

Various configurations of abrasive articles are known, for example, discs, endless belts, sanding sponges, and the like. The configurations of the abrasive article will affect the intended use of the articles. For example, some abrasive articles are configured to be connected to a vacuum source during use, to remove dust and swarf from the abrading surface.

For generally all coated abrasive articles, a backing supports an abrasive layer and may affect the performance of the abrasive article. Although many backings for abrasive articles are known, there is still a need in the art for improved backings.

### BRIEF DESCRIPTION OF THE DRAWINGS

The present disclosure can be better understood, and its numerous features and advantages made apparent to those skilled in the art by referencing the accompanying drawings

FIG. 1 is a schematic cross-sectional view of a first form composite backing material in accordance with an embodiment.

FIG. 2 is a schematic cross-sectional view of a second form composite backing material in accordance with an embodiment.

FIG. 3 illustrates a process of forming a second form composite backing material in accordance with an embodiment.

FIG. 4 illustrates a process of forming a first form composite backing material in accordance with an embodiment.

FIG. 5 illustrates a process of forming a second form composite backing material in accordance with an embodiment.

FIG. 6 illustrates a process of forming a second form composite backing material in accordance with an embodiment.

FIG. 7A illustrates a cross section of an abrasive article that includes a second form composite backing material in accordance with an embodiment.

FIG. 7B illustrates a cross section of an abrasive article that includes a second form composite backing material in accordance with an embodiment.

FIG. 8 is a graph illustrating tensile strength of embodiments described herein.

FIG. 9 is a graph illustrating flexural modulus of embodiments described herein.

FIG. 10 is a graph illustrating cumulative material removal performance of a standard vulcanized fiber sample and an embodiment as described herein.

FIG. 11 illustrates the machine direction (MD) and cross direction (CD) in accordance with an embodiment.

FIG. 12 is a schematic cross-sectional view of a composite backing material in accordance with an another embodiment.

FIG. 13 illustrates a process of forming a second form composite backing material in accordance with another embodiment.

### DETAILED DESCRIPTION

The following is directed to composite backing materials that can be useful in a variety of applications. Among other things, the composite backing materials described herein can be useful in forming coated abrasive articles, which can be useful in a wide variety of grinding and polishing applications, including, high stock removal or polishing of coated or uncoated surfaces, such as wood, stone, metal, ceramic, plastics, glass, and composites.

### Composite Backing Material

A composite backing material according to embodiments described herein can comprise multiple layers. In an embodiment, a composite backing material can be a first form composite backing material or a second form composite backing material. As used herein the term “composite backing material” generally includes and can refer to both first form composite backing materials and second form composite backing materials.

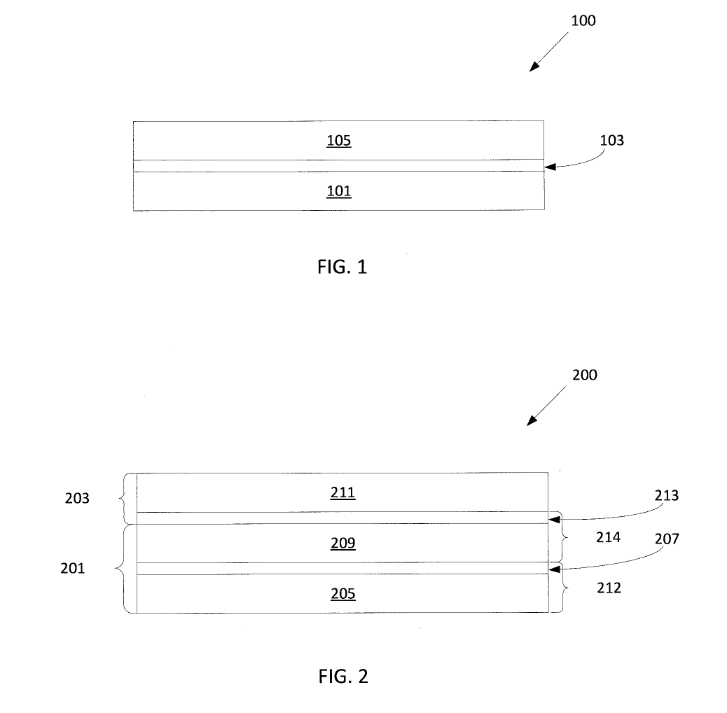

1^{st} form composite backing material—As used herein the term “first form composite backing material”, or alternately written as “1^{st} form composite backing material”, means a composite backing material that comprises a first flexible backing material layer and a natural fiber layer disposed on the first flexible backing material layer. A first form composite backing material can include an adhesive layer between the first flexible backing material layer and the natural fiber layer. In a specific embodiment, as shown in FIG. 1, a first form composite backing material 100 comprises a first flexible backing material layer 101, an adhesive layer 103, and a natural fiber layer 105, wherein the adhesive layer is disposed between the first flexible backing material layer and the natural fiber layer.

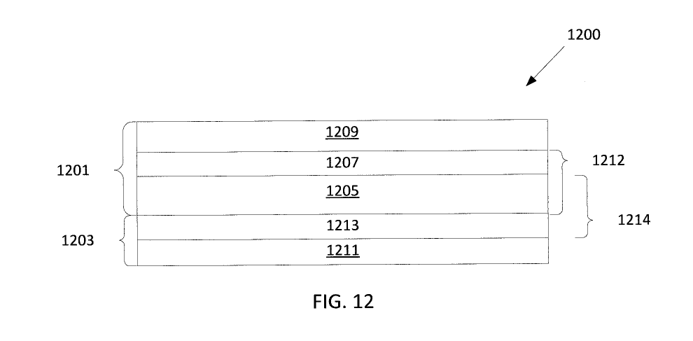

2^{nd} form composite backing material—As used herein a “second form composite backing material”, or alternately written as “2^{nd} form composite backing material” is a first form composite backing material that has a “second stage” disposed on the first form composite backing material. In other words, the first form composite backing material plus the second stage equals the second form composite backing material. A “second stage” can comprise a second flexible backing material layer and adhesive layer or a second natural fiber layer and adhesive layer. In a specific embodiment, a second stage comprises a second flexible backing material layer and an adhesive layer. In another specific embodiment, a second stage comprises a second natural fiber layer and adhesive layer. In a specific embodiment, as shown in FIG. 2, a second form composite backing material 200 comprises a first form composite backing material 201 and a second stage 203, wherein the second stage is disposed on the first form composite backing material. The first form composite backing material comprises a first flexible backing material layer 205, an (first) adhesive layer 207, and a natural fiber layer 209. The second stage comprises a second flexible backing material layer 211 and an (second) adhesive layer 213. The second stage is disposed so that (second) adhesive layer 213 is in contact with the natural fiber layer 209 of the first form composite backing material. In another specific embodiment, as shown in FIG. 12, a second form composite backing material 1200 comprises a first form composite backing material 1201 and a second stage 203, wherein the second stage is disposed on the first form composite backing material. The first form composite backing material comprises a flexible backing material layer 1205, an (first) adhesive layer 1207, and a (first) natural fiber layer 1209. The second stage comprises a second natural fiber layer 1211 and a (second) adhesive layer 1213. The second stage is disposed so that the (second) adhesive layer 1213 is in contact with the flexible backing material layer 1205 of the first form composite backing material.

As described in greater detail herein a composite backing material can have a particular arrangement of layers. The particular arrangement of layers can influence the physical properties of the composite backing material. In turn, a composite backing material embodiment can influence the physical properties and abrasive performance of an abrasive article embodiment that includes the composite backing material. In some embodiments, composite backing materials include multiple layers and can be laminates of one or more backing materials, and can include an adhesive to hold the layers together. In other embodiments, a composite backing material can include one or more treatments for sealing the composite backing material, as a whole, or to seal one or more of the substituent layers of the composite backing material.

A composite backing can be of any shape or conformation that is dictated by the intended use and materials of construction. In a particular embodiment, a composite backing material can be one of a sheet, a belt, a tape, a roll, or a circular disc.

### A (First) Flexible Backing Material Layer

The composite backing material can comprise a flexible backing material layer, such as a single backing material layer, or multiple flexible backing material layers, such as a first flexible backing material layer and a second flexible backing material layer, or even additional flexible backing material layers. Where multiple flexible backing material layers are present the flexible backing material layers can be the same or different from each other.

In an embodiment, the composite backing comprises a flexible backing material layer. In an embodiment, the composite backing comprises a first flexible backing material layer. In an embodiment, the flexible backing material comprises a polymer film, a non-woven fabric, a woven fabric, paper, vulcanized fiber, or a combination thereof. In another embodiment, the flexible backing material layer is a first flexible backing material and can be a polymer film, a non-woven fabric, or any combination thereof. In a specific embodiment, the first flexible backing material layer can comprise a polymer film. In an embodiment, the polymer film can comprise a thermoplastic polymer, a thermoset polymer, or combinations thereof. The polymer film can be a primed film or an unprimed film. In a particular embodiment, the thermoplastic film can be a polyethylene film, a polyvinyl chloride film, or combinations thereof. In another particular embodiment, a thermoset film can be a phenolic film, such as a novolac film.

In an embodiment, the first flexible backing material layer can comprise a non-woven fabric. The non-woven fabric can be a treated fabric (i.e. a “finished” fabric) or an untreated fabric (i.e., an “unfinished” fabric or a “grey” cloth). As used herein, “non-woven” means a web of random or directional fibers held together mechanically, chemically, physically, or a combination thereof. The fibers can be continuous fibers or staple fibers, monofilament or multifilament, and can be formed of various materials, including polymer fibers, plant fibers, or combinations thereof. In an embodiment, suitable non-woven fabrics include fibers formed into a non-woven web that provides a three-dimensional integrated network structure. In particular embodiments, the fibers can be interlocked by a needle punching, hydro-entanglement, or combinations thereof. In a specific embodiment, a non-woven fabric can be a spunlace fabric, which comprises a web of hydroentangled fibres. Such hydroentangled webs are known in the art as “spunlace.” In a particular embodiment, the first flexible backing material layer comprises hydro-entangled fibers, or spunlace fabric.

In an embodiment, a non-woven fabric can comprise a polyester fabric, a cotton fabric, a polycotton fabric, or a combination thereof. In a specific embodiment, the first flexible backing material layer can comprise a polyester-based non-woven spunlace material. In an embodiment, the polyester-based spunlace material of the first flexible backing material layer can comprise a majority content of polyester, such as by volume or by mass. In an embodiment, a polyester-based spunlace material can comprise at least greater than 50%, such as at least about 51%, such as at least about 55%, at least about 60%, at least about 70%, or at least about 75% polyester by total volume or total mass of the first flexible backing material layer. In another embodiment, the polyester-based spunlace material can be 100% polyester. In another embodiment, the polyester-based spunlace material can be a blended material including polyester and another polymer material or inorganic material (such as glass fiber or mineral fiber), wherein at least 75% by volume or by weight of the composite spunlace material is polyester. In yet another embodiment, the polyester-based spunlace material can consist essentially of polyester, and more particularly, can consist essentially of spunlace polyester.

A non-woven material of the first flexible backing material layer can have a particular areal density. In an embodiment, a non-woven material of the first flexible backing material layer can have an areal density of at least 50 grams per square meter (i.e., g/m² or GSM), such as at least about 60 GSM, at least about 70 GSM, at least about 80 GSM, at least about 90 GSM, at least about 100, GSM, at least about 110 GSM, at least about 120 GSM, at least about 130 GSM, at least about 140 GSM, or at least about 150 GSM. In an embodiment, the non-woven material of the first flexible backing material layer can have an areal density of not greater than about 300 GSM, such as, not greater than about 290 GSM, such not greater than about 280 GSM, not greater than about 270 GSM, not greater than about 260 GSM, or not greater than about 250 GSM. It will be appreciated that the non-woven material of the first flexible backing material layer, such as the spunlace polyester-based material, can have an areal density within a range of any of the minimum or maximum values noted above. In a specific embodiment, the non-woven material of the first flexible backing material layer has an areal density in a range of 50 to 300 GSM.

According to another aspect, the non-woven material (e.g., the spunlace polyester-based material) of the first flexible backing material layer can have a particular thickness that facilitates the formation of a coated abrasive article having the features of the embodiments herein. For example, the non-woven backing can have an average thickness of not greater than about 0.9 mm, such as not greater than about 0.8 mm, not greater than about 0.7 mm, not greater than about 0.6 mm, not greater than about 0.5 mm, not greater than about 0.4 mm, or even not greater than about 0.3 mm. Still, in another non-limiting embodiment, the non-woven material of the first flexible backing material layer can have an average thickness of at least about 0.3 mm, such as at least about 0.5 mm, at least about 0.6 mm, at least 0.7 mm, at least 0.8 mm, or even at least 0.9 mm. It will be appreciated that the non-woven material of the backing can have an average thickness within a range of any of the minimum and maximum values noted above. For example, in a particular embodiment the non-woven material of the backing can have an average thickness within a range of about 0.3 mm to about 0.9 mm.

In a particular embodiment, the first flexible backing material layer does not include vulcanized fiber.

The first flexible backing material may optionally have at least one of a saturant, a presize layer or a backsize layer. The purpose of these layers is typically to seal the first flexible backing material or to protect yarn or fibers in the first flexible backing material. If the first flexible backing material is a cloth material, one or more of these layers can be used. The addition of a presize layer or backsize layer can result in a “smoother” surface on either the front or the back side of the first flexible backing material.

In accordance with a particular embodiment, the first flexible backing material layer may include a non-woven material including a polyester-based spunlace material as noted herein. More particularly, the non-woven material (e.g., the spunlace polyester-based material) of the first flexible backing material layer may have one or more particular mechanical properties that may facilitate the formation of a coated abrasive article having any of the features of the embodiments herein. For example, in one embodiment, the non-woven material, such as the spunlace polyester-based material, can have a machine-direction (MD) stiffness of at least about 80 MPa as measured using an Instron 5982 with a 2 kN load cell. The samples had a total sample length of 200 mm, a sample width of 25 mm, a gauge length of 127 mm, and were tested at a deformation rate of 300 mm/min. The modulus values were generated from stress-strain data. The stiffness values are obtained from the initial slope of the stress-strain data. In another embodiment, the non-woven material, such as the spunlace polyester-based material, can have a machine-direction (MD) stiffness of at least about 90 MPa, at least about 100 MPa, at least about 110 MPa, at least about 120 MPa. Still, in another non-limiting embodiment, the non-woven material, such as the spunlace polyester-based material, of the first flexible backing material layer can have a machine-direction (MD) stiffness that is not greater than about 220 MPa, such as not greater than about 210 MPa, not greater than about 200 MPa, not greater than about 190 MPa, not greater that about 180 MPa, or even not greater than about 160 MPa. It will be appreciated that the non-woven material, such as the spunlace polyester-based material, of the first flexible backing material layer can have a machine-direction (MD) stiffness that is within a range of any of the minimum and maximum values noted above. For example, in a particular embodiment, the non-woven material, such as the spunlace polyester-based material, of the first flexible backing material layer can have a machine-direction (MD) stiffness that is within a range of about 80 MPa to about 220 MPa.

In accordance with another embodiment, the first flexible backing material layer can include a non-woven material, such as the spunlace polyester-based material, that may have a particular cross-direction (CD) stiffness, and which may facilitate certain properties of the coated abrasive article. For example, in one embodiment, the non-woven material, such as the spunlace polyester-based material, can have a cross-direction (CD) stiffness of the least about 1 MPa as measured using an Instron 5982 with a 2 kN load cell. The samples had a total sample length of 200 mm, a sample width of 25 mm, a gauge length of 127 mm, and were tested at a deformation rate of 300 mm/min. The modulus values were generated from stress-strain data. The stiffness values are obtained from the initial slope of the stress-strain data. For example, in one embodiment, the non-woven material, such as the spunlace polyester-based material, can have a cross-direction stiffness of the least about 1 MPa as measured using an Instron 5982 with a 2 kN load cell. The samples had a total sample length of 200 mm, a sample width of 25 mm, a gauge length of 127 mm, and were tested at a deformation rate of 300 mm/min. The modulus values were generated from stress-strain data. In another embodiment, the non-woven material, such as the spunlace polyester-based material, can have a cross-direction stiffness of at least about 2 MPa, such as at least about 3 MPa, at least about 5 MPa, or even at least about 8 MPa. In yet another embodiment, the non-woven material, such as the spunlace polyester-based material, can have a cross-direction stiffness that is not greater than about 40 MPa, such as, not greater than about 38 MPa, not greater than about 35 MPa, not greater about 33 MPa, not greater than about 30 MPa, or even not greater than about 28 MPa. It will be appreciated that, that the non-woven material, such as the spunlace polyester-based material, can have a cross-direction stiffness within a range between any of the minimum and maximum values noted above. For example, in a particular embodiment, the non-woven material, such as the spunlace polyester-based material, of the first flexible backing material layer can have a cross-direction (CD) stiffness that is within a range of about 1 MPa to about 40 MPa.

In an embodiment, the first flexible backing material layer can have a specific or variable flexural strength.

### Natural Fiber Layer

The composite backing material can comprise a natural fiber layer, such as a single natural fiber layer, or multiple natural fiber layers, such as a first natural fiber layer and a second natural fiber layer, or even additional natural fiber layers. Where multiple natural fiber layers are present the natural fiber layers can be the same or different from each other.

In an embodiment, a composite backing material comprises a natural fiber layer. As used herein, the term “natural fiber layer” means a layer comprised of at least one natural fiber. Also, the term “natural fiber layer” means that the layer comprises a majority (i.e., greater than 50% by mass or volume up to 100% by mass or volume) of a natural fiber or a blend of natural fibers. The natural fiber layer 105 can comprise one or more natural fibers. In an embodiment, the natural fiber layer can comprise at least one natural fiber selected from the group consisting of jute, hemp, cotton, kenaf, coir, or combinations thereof. In certain embodiments the natural fiber layer comprises jute. As used herein the term “jute” refers to natural fibers derived from plants of the genus Corchorus and family Sparrmanniaceae (formerly, classified in family Tiliaceae or Malvaceae). “Jute” is also the name of the plant or fiber that is used to make burlap cloth, Hessian cloth, gunny cloth, and the like. Burlap cloth, Hessian cloth, and gunny cloth are woven fabrics made of jute fiber. In an embodiment, the natural fiber layer comprises a woven jute fabric. In a particular embodiment, the natural fiber layer comprises burlap cloth, Hessian cloth, gunny cloth, or combinations thereof.

In an embodiment, a natural fiber layer comprises a natural fiber, a synthetic fiber, or a mixture thereof. In a embodiment, the fiber mixture comprises at least 60-80% by weight or by volume of natural fiber. In an embodiment, the fiber mixture comprises at least 20-40% of synthetic fiber.

The natural fiber layer can comprise a woven fabric, a non-woven fabric, a knit fabric, or combinations thereof. In particular embodiments the natural fiber layer comprises a woven fabric. The woven fabric can have a specific or variable warp yarns (alternatively referred to as ends per inch, or EPI) and weft yarns (alternatively referred to as picks per inch, or PPI). The warp count and weft count indicates the thickness of the yarns. In an embodiment, the warp count can be at least 1, such as at least 2, at least 3, at least 4, at least 5, at least 6, at least 7, at least 8, at least 9, or even at least 10. In an embodiment, the warp count can be not greater than 10, such as not greater than 9, not greater than 8, not greater than 7, not greater than 6, not greater than 5, not greater than 4, not greater than 3, not greater than 2, or even not greater than 1. In a non-limiting embodiment, the warp count of the woven fabric can be within a range of any maximum or minimum value indicated above. In a particular embodiment, the warp count can be in a range of 1.5 to 3.0.

In an embodiment, the weft count can be at least 1, such as at least 2, at least 3, at least 4, at least 5, at least 6, at least 7, at least 8, at least 9, or even at least 10. In an embodiment, the weft count can be not greater than 10, such as not greater than 9, not greater than 8, not greater than 7, not greater than 6, not greater than 5, not greater than 4, not greater than 3, not greater than 2, or even not greater than 1. In a non-limiting embodiment, the weft count of the woven fabric can be within a range of any maximum or minimum value indicated above. In a particular embodiment, the weft count can be in a range of 1.5 to 3.0.

The natural fiber layer can comprise a woven fabric having a particular thread count in the warp direction. In an embodiment, the thread count in the warp direction can be at least 5, such as at least 6, at least 7, at least 8, at least 9, at least 10, at least 11, at least 12, at least 13, at least 14, at least 15, at least 16, at least 17, at least 18, at least 19, or even at least 20. In an embodiment, the thread count in the warp direction can be not greater than 20, such as not greater than 19, not greater than 18, not greater than 17, not greater than 16, not greater than 15, not greater than 14, not greater than 13, not greater than 12, not greater than 11, not greater than 10, not greater than 9, not greater than 8, not greater than 7, not greater than 6, or even not greater than 5. In a non-limiting embodiment, the thread count in the warp direction of the woven fabric can be within a range of any maximum or minimum value indicated above.

The natural fiber layer can comprise a woven fabric having a particular thread count in the weft direction. In an embodiment, the thread count in the weft direction can be at least 5, such as at least 6, at least 7, at least 8, at least 9, at least 10, at least 11, at least 12, at least 13, at least 14, at least 15, at least 16, at least 17, at least 18, at least 19, or even at least 20. In an embodiment, the thread count in the weft direction can be not greater than 20, such as not greater than 19, not greater than 18, not greater than 17, not greater than 16, not greater than 15, not greater than 14, not greater than 13, not greater than 12, not greater than 11, not greater than 10, not greater than 9, not greater than 8, not greater than 7, not greater than 6, or even not greater than 5. In a non-limiting embodiment, the thread count in the weft direction of the woven fabric can be within a range of any maximum or minimum value indicated above.

In an embodiment, the natural fiber can have a specific or variable weight. The weight can be at least 100 grams per square meter (GSM), such as at least 125 GMS, at least 150 GMS, at least 175 GMS, at least 200 GMS, at least 225 GSM, at least 250 GSM, at least 275 GSM, at least 300 GSM, at least 325 GSM, or at least 350 GSM. In an embodiment, the weight can be not greater than 350 GSM, such as not greater than 325 GSM, not greater than 300 GSM, not greater than 275 GSM, not greater than 250 GSM, not greater than 225 GSM, not greater than 200 GSM, not greater than 175 GSM, not greater than 150 GSM, not greater than 125 GSM, or not greater than 100 GSM. It will be appreciated that the weight can be in a range of any maximum or minimum value indicated above.

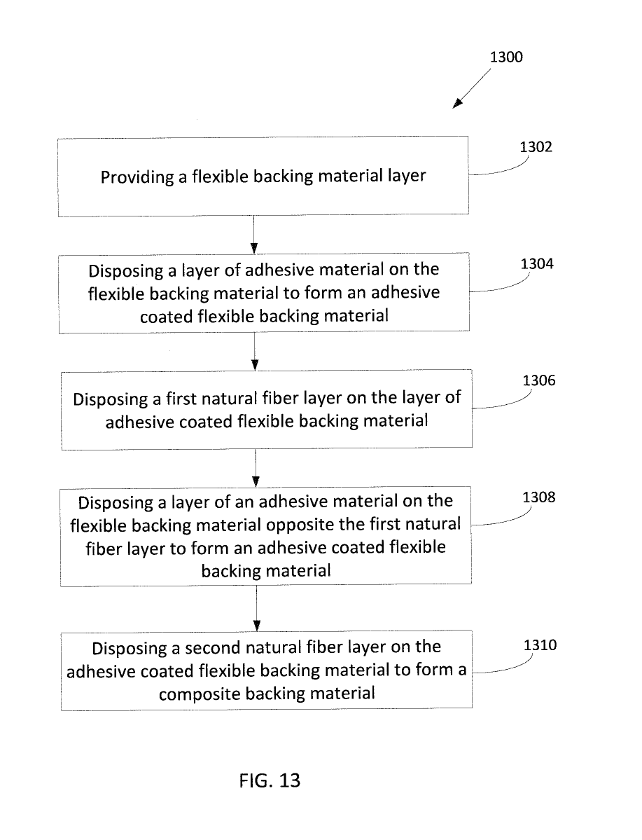

In an embodiment, the natural fiber can have a specific or variable tensile strength as measured in a machine direction (MD) and/or a cross direction (CD) of a sheet of natural fiber. As used herein, and as illustrated in FIG. 13, machine direction (MD) means the direction of paper grain which is run along the track of paper machine, and cross direction (CD) means the direction of paper which is run vertical upright to the grain of the paper. It will be appreciated that tensile strength measured in the MD and the CD are applicable to paper, fabric, fiber, or otherwise any sheet of material having a grain direction. It will also be appreciated that the tensile strength of the natural fiber can correspond to certain weights of the natural fiber, as described herein.

In an embodiment, the tensile strength in the machine direction (MD) can be at least about 5 kg/25 mm, such as at least about 10 kg/25 mm, such as at least about 15 kg/25 mm, at least about 20 kg/25 mm, at least about 21 kg/25 mm, at least about 22 kg/25 mm, at least about 23 kg/25 mm, at least about 24 kg/25 mm, at least about 25 kg/25 mm, at least about 26 kg/25 mm, at least about 26 kg/25 mm, at least about 27 kg/25 mm, at least about 28 kg/25 mm, at least about 29 kg/25 mm, at least about 30 kg/25 mm, at least about 35 kg/25 mm, at least about 36 kg/25 mm, at least about 37 kg/25 mm, at least about 38 kg/25 mm, at least about 39 kg/25 mm, or even at least about 40 kg/25 mm. In an embodiment, the tensile strength machine direction (MD) can be not greater than about 40 kg/25 mm, such as not greater than 39 kg/25 mm, not greater than about 38 kg/25 mm, not greater than about 37 kg/25 mm, not greater than about 36 kg/25 mm, not greater than about 35 kg/25 mm, not greater than about 30 kg/25 mm, not greater than about 29 kg/25 mm, not greater than about 28 kg/25 mm, not greater than about 27 kg/25 mm, not greater than about 26 kg/25 mm, not greater than about 25 kg/25 mm, not greater than about 24 kg/25 mm, not greater than about 23 kg/25 mm, not greater than about 22 kg/25 mm, not greater than about 21 kg/25 mm, not greater than about 20 kg/25 mm, not greater than about 15 kg/25 mm, or even not greater than about 10 kg/25 mm. It will be appreciated that the tensile strength in the machine direction (MD) can be in a range of any two values indicated above. In a particular embodiment, the tensile strength in the machine direction (MD) can be in a range of 10 kg/25 mm to 40 kg/25 mm.

In an embodiment, the tensile strength in the cross-direction (CD) can be at least about 5 kg/25 mm, such as at least about 10 kg/25 mm, such as at least about 15 kg/25 mm, at least about 20 kg/25 mm, at least about 21 kg/25 mm, at least about 22 kg/25 mm, at least about 23 kg/25 mm, at least about 24 kg/25 mm, at least about 25 kg/25 mm, at least about 26 kg/25 mm, at least about 26 kg/25 mm, at least about 27 kg/25 mm, at least about 28 kg/25 mm, at least about 29 kg/25 mm, at least about 30 kg/25 mm, at least about 35 kg/25 mm, at least about 36 kg/25 mm, at least about 37 kg/25 mm, at least about 38 kg/25 mm, at least about 39 kg/25 mm, or even at least about 40 kg/25 mm. In an embodiment, the tensile strength in either the cross direction (CD) can be not greater than about 40 kg/25 mm, such as not greater than 39 kg/25 mm, not greater than about 38 kg/25 mm, not greater than about 37 kg/25 mm, not greater than about 36 kg/25 mm, not greater than about 35 kg/25 mm, not greater than about 30 kg/25 mm, not greater than about 29 kg/25 mm, not greater than about 28 kg/25 mm, not greater than about 27 kg/25 mm, not greater than about 26 kg/25 mm, not greater than about 25 kg/25 mm, not greater than about 24 kg/25 mm, not greater than about 23 kg/25 mm, not greater than about 22 kg/25 mm, not greater than about 21 kg/25 mm, not greater than about 20 kg/25 mm, not greater than about 15 kg/25 mm, or even not greater than about 10 kg/25 mm. It will be appreciated that the tensile strength in the cross direction (CD) can be in a range of any two values indicated above. In a particular embodiment, the tensile strength in the cross direction (CD) can be in a range of 10 kg/25 mm to 40 kg/25 mm.

In particular embodiments, the tensile strength of the natural fiber in the machine direction (MD) can be in a range of 20 kg/25 mm to 30 kg/25 mm, as tested using an Instron 5982 with a 2 kN load cell, wherein the samples had a total sample length of 200 mm, a sample width of 25 mm, a gauge length of 127 mm, and were tested at a deformation rate of 300 mm/min. In a particular embodiment the tensile strength of the natural fiber in the machine direction (MD) can be in a range of 23 kg/25 mm to 27 kg/25 mm.

In particular embodiments, the tensile strength of the natural fiber in the cross-direction (CD) can be in a range of 20 kg/25 mm to 30 kg/25 mm. In a particular embodiment, the tensile strength of the natural fiber in the cross-direction (CD) can be in a range of 20 kg/25 mm to 27 kg/25 mm. In yet another particular embodiment, the tensile strength of the natural fiber in the cross-direction (CD) can be in a range of 22 kg/25 mm to 25 kg/25 mm.

In an embodiment, the natural fiber layer 105 can have a specific or variable total thickness.

### Second Flexible Backing Material Layer

As stated previously, the composite backing material can include a second flexible backing material. The second flexible backing material layer can be made of any number of various materials. In an embodiment, the second flexible backing material layer can comprise any material described herein with respect to the first flexible backing material layer. In an embodiment the second flexible backing material layer can comprise woven fabric, paper, vulcanized fiber, or a combination thereof.

In an embodiment, the second flexible backing material layer comprises vulcanized fiber. In a particular embodiment the vulcanized fiber can have a particular thickness. In a specific embodiment, the vulcanized fiber is in a range of about 0.1 mm to 0.5 mm.

In a particular embodiment, the second flexible backing material layer comprises a woven fabric. In particular embodiments, the woven fabric can include cotton, polycotton, or polyester.

The woven fabric can have a specific or variable warp and weft. For polyester and polycotton, the number of yarns in the warp direction is about 100 and about 55 in the weft direction. For cotton, the corresponding values are 78 and 48. A woven fabric can have a specific or variable thread count. In particular, a woven fabric can have a specific or variable thread count in a weft direction and in a warp direction. In an embodiment, the thread count in the weft direction can be at least about 35, such as at least about 40, at least about 45, at least about 50, at least about 55, at least about 60, at least about 65, at least about 70, or even al least about 75. In an embodiment, the thread count in the weft direction can be not greater than about 75, such as not greater than about 70, not greater than about 65, not greater than about 60, not greater than about 55, not greater than about 50, not greater than about 45, not greater than about 40, not greater than about 35, or even not greater than about 30. In a non-limiting embodiment, the thread count of the woven fabric in the weft direction can be within a range of any maximum or minimum value indicated above. For example, in a particular embodiment, the thread count of the woven fabric in the weft direction can be within about 50 and about 60. In a certain embodiment, the thread count of the woven fabric in the weft direction can be about 55. In another particular embodiment, the thread count of the woven fabric in the weft direction can be within about 45 and about 50. In a certain embodiment, the thread count of the woven fabric in the weft direction can be about 48.

In an embodiment, the thread count in the warp direction can be at least about 50, such as at least about 60, at least about 70, at least about 80, at least about 90, at least about 100, at least about 110, at least about 120, or even al least about 130. In an embodiment, the thread count in the warp direction can be not greater than about 130, such as not greater than about 120, not greater than about 110, not greater than about 100, not greater than about 90, not greater than about 80, not greater than about 70, not greater than about 60, or even not greater than about 50. In a non-limiting embodiment, the thread count of the woven fabric in the warp direction can be within a range of any maximum or minimum value indicated above. For example, in a particular embodiment, the thread count of the woven fabric in the warp direction can be within about 90 and about 110. In a certain embodiment, the thread count of the woven fabric in the warp direction can be about 100. In another particular embodiment, the thread count of the woven fabric in the warp direction can be within about 70 and about 80. In a certain embodiment, the thread count of the woven fabric in the warp direction can be about 78.

In accordance with an embodiment, the second flexible backing material layer can have a specific or variable machine-direction (MD) stiffness, and which may facilitate certain properties of the coated abrasive article.

In accordance with another embodiment, the second flexible backing material layer can include a cross-direction (CD) stiffness, and which may facilitate certain properties of the coated abrasive article.

In an embodiment, the second flexible backing material layer can include a thickness that facilitates the formation of a coated abrasive article having the features of the embodiments herein. The thickness can be any thickness described herein with respect to the first flexible backing material layer. In another embodiment, the woven material of the second flexible backing material layer can have a can have an average thickness of not greater than about 0.6 mm, such as not greater than about 0.5 mm, not greater than about 0.4 mm, or even not greater than about 0.3 mm. Still, in another non-limiting embodiment, the non-woven material of the second flexible backing material layer can have an average thickness of at least about 0.3 mm, such as at least about 0.4 mm, at least about 0.5 mm, or even at least about 0.6 mm. It will be appreciated that the woven material of the second flexible material layer can have an average thickness within a range of any of the minimum and maximum values noted above. For example, in a particular embodiment the woven material of the second flexible material layer can have an average thickness within a range of about 0.3 mm to about 0.6 mm.

In an embodiment, the second flexible backing material layer can include a specific or variable flexural strength.

In an embodiment, the woven fabric can have a specific or variable weight. The weight can be at least 100 grams per square meter (GSM), such as at least 125 GMS, at least 150 GMS, at least 175 GMS, at least 200 GMS, at least 225 GSM, at least 250 GSM, at least 275 GSM, at least 300 GSM, at least 325 GSM, at least 350 GSM, at least 375 GSM, at least 400 GSM, at least 425 GSM, at least 450 GSM, at least 475 GSM, or at least 500 GSM. In an embodiment, the weight can be not greater than 500 GSM, such as not greater than 475 GSM, not greater than 450 GSM, not greater than 425 GSM, not greater than 400 GSM, not greater than 375 GSM, not greater than 350 GSM, not greater than 325 GSM, not greater than 300 GSM, not greater than 275 GSM, not greater than 250 GSM, not greater than 225 GSM, not greater than 200 GSM, not greater than 175 GSM, not greater than 150 GSM, not greater than 125 GSM, or not greater than 100 GSM. It will be appreciated that the weight can be in a range of any maximum or minimum value indicated above.

In an embodiment, the woven fabric can have a specific or variable tensile strength as measured in a machine direction (MD) and/or a cross direction (CD) of a sheet of natural fiber.

### Adhesive Layers

The composite backing material can comprise an adhesive layer, such as a single adhesive layer, or multiple adhesive layers, such as a first adhesive layer and a second adhesive layer, or even additional adhesive layers. Where multiple adhesive layers are present the adhesive layers can be the same or different from each other.

In an embodiment, a composite backing material can include one or more adhesive layers. An adhesive layer can comprise an epoxy adhesive, an acrylic adhesive, a latex adhesive, a polyvinyl acetate adhesive, a silicone adhesive, a polyimide adhesive, a polyurethane adhesive, or combinations thereof. As illustrated in FIG. 2, a composite backing material 200 can include an adhesive layer 208 disposed between a first flexible backing material layer 202 and a natural fiber layer 204. The composite backing material 200 can also include a second adhesive layer 210 disposed between a second flexible backing material layer 206 and the natural fiber layer 204.

In an embodiment, at least one of the one or more adhesive layers comprise a water based adhesive. For example, a water based adhesive can include a latex-based adhesive. In an embodiment, a water-based adhesive can include an aqueous emulsion of natural rubber, styrene-butadiene rubber, acrylonitrile butadiene rubber, acrylic polymers, or polyvinyl acetate, epoxy resin, or combinations thereof. In a specific embodiment, the one or more adhesive layers comprise an epoxy adhesive.

### Method for Forming Composite Backing Material Layer

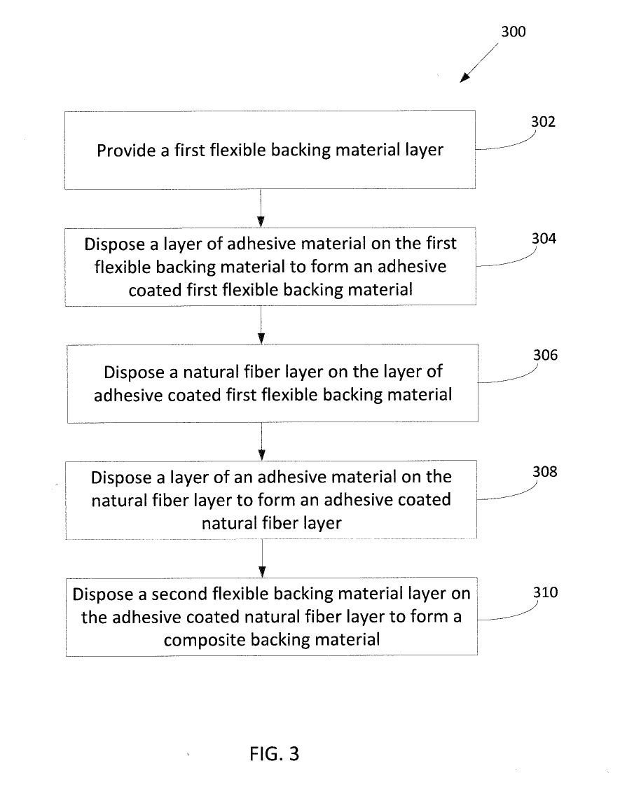

In an embodiment, a composite backing material can be formed by any method known in the art. In a particular embodiment, a second form composite backing material 200 as illustrated in FIG. 2 can be formed by the method 300 illustrated in FIG. 3. As illustrated in FIG. 3, a method 300 for forming a second form composite backing material 200 comprises providing a first flexible backing material layer 205 in step 302. The method 300 can continue in step 304 by disposing a (first) layer of adhesive material 207 on the first flexible backing material 205 to form an adhesive coated first flexible backing material 212. The method 300 can continue in step 306 by disposing a natural fiber layer 209 on the (first) layer of adhesive 207 of the adhesive coated first flexible backing material 212 to form a 1^{st} form composite backing material 201. The method 300 can continue in step 208 by disposing a (second) layer of an adhesive material 213 on the natural fiber layer 209 to form an adhesive coated natural fiber layer 214. The method 300 can continue in step 310 by disposing a second flexible backing material layer 211 on the adhesive coated natural fiber layer 214 to form a second form composite backing material 200.

In an embodiment, forming a composite backing material can comprise one or more curing steps. For example, the adhesive coated first flexible backing material 212 can be at least partially cured prior to disposing the natural fiber layer 209 of step 306. In another embodiment, the adhesive coated natural fiber layer 214 can be at least partially cured prior to disposing the second flexible backing material layer 211 of step 310.

In another particular embodiment, a second form composite backing material 1200 as illustrated in FIG. 12 can be formed by the method 1300 illustrated in FIG. 13. As illustrated in FIG. 13, a method 1300 for forming a second form composite backing material 1200 comprises providing a flexible backing material layer 1205 in step 1302. The method 1300 can continue in step 304 by disposing a (first) layer of adhesive material 207 on the first flexible backing material 205 to form an adhesive coated first flexible backing material 212. The method 300 can continue in step 306 by disposing a natural fiber layer 1209 on the (first) layer of adhesive 1207 of the adhesive coated first flexible backing material 1212 to form a 1^{st} form composite backing material 1201. The method 1300 can continue in step 1308 by disposing a (second) layer of an adhesive material 1213 on the flexible backing material 209 opposite the first natural fiber layer to form an adhesive coated natural fiber layer 1214. The method 1300 can continue in step 1310 by disposing a second flexible backing material layer 1211 on the adhesive coated natural fiber layer 1214 to form a second form composite backing material 1200.

In an embodiment, forming a composite backing material can comprise one or more curing steps. For example, the adhesive coated first flexible backing material 1212 can be at least partially cured prior to disposing the natural fiber layer 1209 of step 1306. In another embodiment, the adhesive coated natural fiber layer 1214 can be at least partially cured prior to disposing the second natural fiber layer 1211 of step 1310.

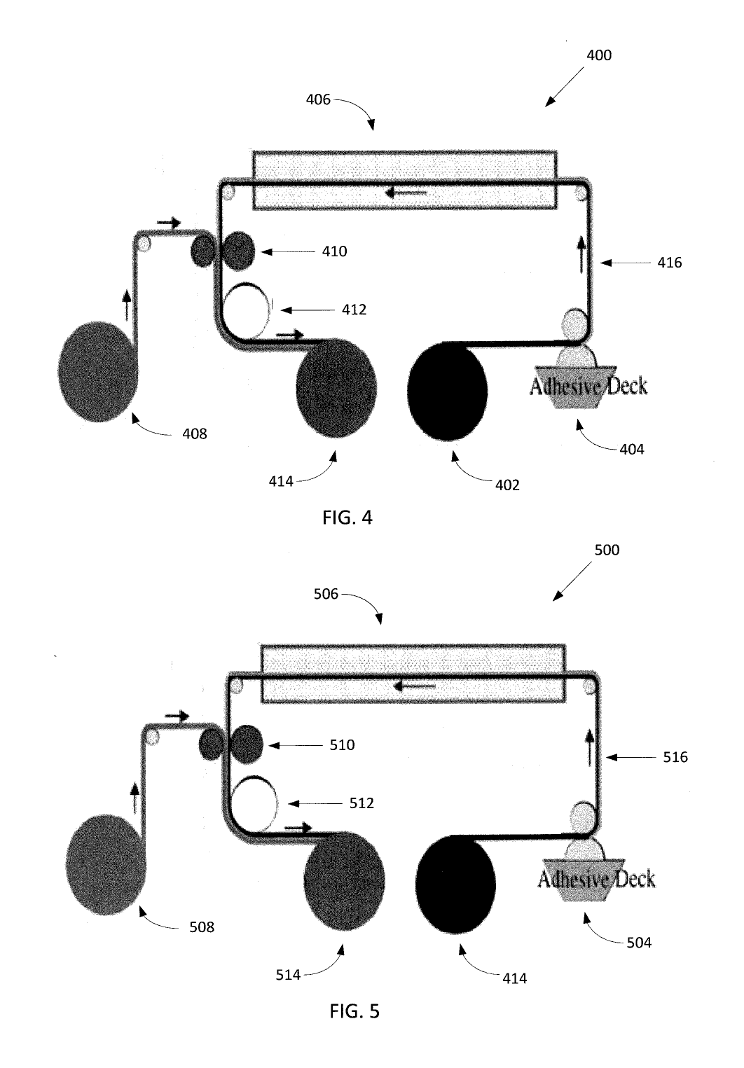

FIG. 4 illustrates a process 400 of forming a composite backing material in accordance with an embodiment. As illustrated, a first flexible backing material layer 402 can be provided to an adhesive deck 404 for disposing a (first) layer of adhesive material on the first flexible backing material 402 to form an adhesive coated first flexible backing material 416. The adhesive coated first flexible backing material 416 can optionally be at least partially cured by, for example, providing the adhesive coated first flexible backing material 416 through an oven 406. A natural fiber layer 406 can be disposed on the (first) layer of adhesive of the adhesive coated first flexible backing material 416 to form 1^{st} form composite backing material 414. In an embodiment, a nip roll 410 can be used to press the natural fiber layer 406 and the adhesive coated first flexible backing material 416 together. In a particular embodiment employing the use of an oven, a chill roll 412 can be used to reduce the temperature of the layer extruded from the oven 406, preferably after the natural fiber layer 406 has been pressed together with the adhesive coated first flexible backing material 416.

FIG. 5 illustrates a process 500 of forming a composite backing material in accordance with an embodiment. As illustrated, 1^{st} form composite backing material 414 of FIG. 4 can be provided to an adhesive deck 504 for disposing a (second) layer of adhesive material on the 1^{st} form composite backing material 414 to form an adhesive coated 1^{st} form composite backing material 516. The adhesive coated 1^{st} form composite backing material 516 can optionally be at least partially cured by, for example, providing the adhesive coated 1^{st} form composite backing material 516 through an oven 506. A second flexible backing material layer 508 can be disposed on the (second) layer of adhesive of the adhesive coated 1^{st} form composite backing material 516 to form final composite backing material layer 514. In an embodiment, a nip roll 510 can be used to press the natural fiber layer 506 and the adhesive coated 1^{st} form composite backing material 516 together. In a particular embodiment employing the use of an oven, a chill roll 512 can be used to reduce the temperature of the layer extruded from the oven 506, preferably after the second flexible backing material layer 508 has been pressed together with the adhesive coated 1^{st} form composite backing material 516.

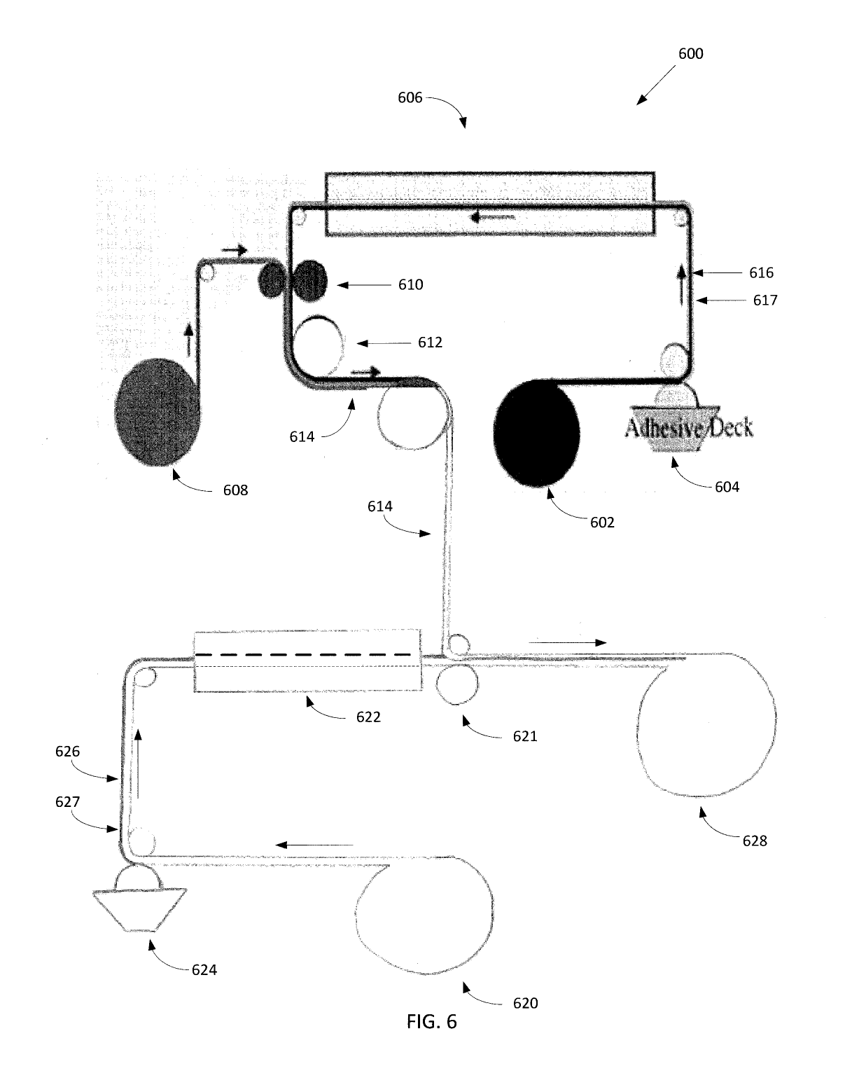

FIG. 6 illustrates a process 600 of forming a composite backing material in accordance with an embodiment. As illustrated, a first flexible backing material layer 602 can be provided to an adhesive deck 604 for disposing a first adhesive layer 617 on the first flexible backing material 602 to form an adhesive coated first flexible backing material 616. The adhesive coated first flexible backing material 616 can optionally be at least partially cured by, for example, providing the adhesive coated first flexible backing material 616 through an oven 606. A natural fiber layer 606 can be disposed on the layer of adhesive of the adhesive coated first flexible backing material 616 to form a 1^{st} form composite backing material 614. In an embodiment, a nip roll 610 can be used to press the natural fiber layer 606 and the adhesive coated first flexible backing material 616 together. In a particular embodiment employing the use of an oven, a chill roll 612 can be used to reduce the temperature of the layer extruded from the oven 606, preferably after the natural fiber layer 606 has been pressed together with the adhesive coated first flexible backing material 616.

FIG. 6 further illustrates that a second flexible backing material layer 620 can be disposed on the 1^{st} form composite backing material 614 to form final composite backing material layer 628. In an embodiment, the second flexible backing material layer 620 can be provided to an adhesive deck 624 for disposing a second adhesive layer 627 on the second flexible backing material 620 to form the adhesive coated second flexible backing material 626. Although not shown in FIG. 6, the second adhesive layer 627 can alternatively be disposed on the 1^{st} form composite backing material 614 to form an adhesive coated 1^{st} form composite backing material. The adhesive coated second flexible backing material 626, or alternatively the adhesive coated 1^{st} form composite backing material, can optionally be at least partially cured by, for example, providing the adhesive coated second flexible backing material 626, or alternatively the adhesive coated 1^{st} form composite backing material, through an oven 622. In an embodiment, a nip roll 621 can be used to press the adhesive coated second flexible backing material 626, or alternatively the adhesive coated 1^{st} form composite backing material, together. In a particular embodiment employing the use of an oven, a chill roll 512 can be used to reduce the temperature of the layer extruded from the oven 622, preferably after the adhesive coated second flexible backing material 626 has been pressed together with the 1^{st} form composite backing material 614, or alternatively after the adhesive coated 1^{st} form composite backing material has been pressed together with the second flexible backing material layer 620.

### Characteristics of Composite Backing Material Layer

In an embodiment, the composite backing material layer can include a particular thickness. The thickness can be at least at least about 0.5 mm, such as at least about 0.6 mm, at least about 0.7 mm, at least about 0.8 mm, at least about 0.9 mm, at least about 1.0 mm, at least about 1.2 mm, at least about 1.4 mm, or even at least about 1.5 mm, at least 1.6 mm, at least 1.8 mm, at least 2.0 mm at least about 2.5 mm, at least about 3.0 mm, at least about 3.5 mm, at least about 4.0 mm, at least about 4.5 mm, or even at least about 5.0 mm. In an embodiment, the thickness can be not greater than about 5.0 mm, such as not greater than about 4.5 mm, not greater than about 4.0 mm, not greater than about 3.5, not greater than about 3.0 mm, not greater than about 2.5 mm, not greater than about 2.0 mm, not greater than 1.8 mm, not greater than 1.6 mm, not greater than about 1.5 mm, not greater than about 1.4 mm, not greater than about 1.3 mm, not greater than 1.2 mm, not greater than 1.0 mm, not greater than 0.9 mm, not greater than 0.8 mm, not greater than about 0.7 mm, not greater than about 0.6 mm, or even not greater than about 0.5 mm. In a non-limiting embodiment, the thickness can be in a range of any maximum or minimum value indicated above. For example, the thickness of the composite backing material layer can be in a range of about 0.6 mm to about 1.5 mm. In another particular embodiment, the thickness of the composite backing material layer can be in a range of about 0.5 mm to about 5.0 mm.

In accordance with an embodiment, the composite backing material layer may have particular mechanical properties that can facilitate the formation of a coated abrasive article having the features of the embodiments herein. For example, in at least one embodiment, the composite backing material layer 100, 200, can have a machine-direction (MD) stiffness of at least 1200 MPa as measured using an Instron 5982 with a 2 kN load cell. The samples had a total sample length of 200 mm, a sample width of 25 mm, a gauge length of 127 mm, and were tested at a deformation rate of 300 mm/min. The modulus values were generated from stress-strain data. In another embodiment, the composite backing material layer can have a stiffness in the machine direction (MD) of at least about 1300 MPa, at least about 1400 MPa, at least about 1500 MPa, at least about 1600 MPa, at least about 1800 MPa, at least about 1900 MPa, or at least about 2000 MPa. In an embodiment, the composite backing material layer can have a stiffness in the machine direction (MD) of not greater than about 2000 MPa, such as not greater than about 1900 MPa, not greater than about 1800 MPa, not greater than about 1700 MPa, not greater than about 1600 MPa, not greater than about 1500 MPa, not greater than about 1400 MPa, not greater than about 1300 MPa, or even not greater than about 1200 MPa. It will be appreciated that the composite backing material layer can have a stiffness in the machine direction (MD) in a range of any two values indicated above. For example, in a particular embodiment, the composite backing material layer can have a stiffness in the machine direction (MD) in a range of about 1400 MPa to about 1500 MPa. In another particular embodiment, the composite backing material layer can have a stiffness in the machine direction (MD) in a range of about 1500 MPa to about 1600 MPa. In yet another particular embodiment, the composite backing material layer can have a stiffness in the machine direction (MD) in a range of about 1700 MPa to about 1800 MPa.

In yet another embodiment, the composite backing material layer may have a cross-direction (CD) stiffness of at least 900 MPa as measured using an Instron 5982 with a 2 kN load cell. The samples had a total sample length of 200 mm, a sample width of 25 mm, a gauge length of 127 mm, and were tested at a deformation rate of 300 mm/min. The modulus values were generated from stress-strain data. In another embodiment, the composite backing material layer can have a stiffness in the cross direction (CD) of at least about 1000 MPa, at least about 1100 MPa, at least about 1200 MPa, at least about 1300 MPa, at least about 1400 MPa, at least about 1500 MPa, at least about 1600 MPa, at least about 1700 MPa, or even at least about 1800 MPa. In an embodiment, the composite backing material layer can have a stiffness in the cross direction (CD) of not greater than about 1800 MPa, such as not greater than about 1700 MPa, not greater than about 1600 MPa, not greater than about 1500 MPa, not greater than about 1400 MPa, not greater than about 1300 MPa, not greater than about 1200 MPa, not greater than about 1100 MPa, not greater than about 1000 MPa or even not greater than about 900 MPa. It will be appreciated that the composite backing material layer can have a stiffness in the cross direction (CD) in a range of any two values indicated above. For example, the composite backing material layer can have a stiffness in the cross direction in a range of about 900 MPa to about 1000 MPa. In another particular embodiment, the composite backing material layer can have a stiffness in the cross direction (CD) in a range of about 1000 MPa to about 1100 MPa. In yet another particular embodiment, the composite backing material layer can have a stiffness in the cross direction (CD) in a range of about 1500 MPa to about 1600 MPa.

In an embodiment, the composite backing material layer can have a specific or variable tensile strength. For example, the composite backing material layer can have a tensile strength in the machine direction (MD) of at least about 100 kg/25 mm, such as at least about 110 kg/25 mm, at least about 120 kg/25 mm, at least about 130 kg/25 mm, at least about 140 kg/25 mm, at least about 150 kg/25 mm, at least about 160 kg/25 mm, at least about 170 kg/25 mm, at least about 180 kg/25 mm, at least about 190 kg/25 mm, or even at least about 200 kg/25 mm. In a non-limiting embodiment, the composite backing material layer can have a tensile strength in the machine direction (MD) of not greater than about 200 kg/25 mm, such as not greater than about 190 kg/25 mm, not greater than about 180 kg/25 mm, not greater than about 170 kg/25 mm, not greater than about 160 kg/25 mm, not greater than about 150 kg/25 mm, not greater than about 140 kg/25 mm, not greater than about 130 kg/25 mm, not greater than about 120 kg/25 mm, not greater than about 110 kg/25 mm, or even not greater than about 100 kg/25 mm. It will be appreciated that the composite backing material layer can have a tensile strength in the machine direction (MD) in a range of any two values indicated above. For example, in a particular embodiment, the composite backing material layer can have a tensile strength in the machine direction (MD) in a range of about 110 kg/25 mm to about 120 kg/25 mm. In another particular embodiment, the composite backing material layer can have a tensile strength in the machine direction (MD) in a range of about 150 kg/25 mm to about 160 kg/25 mm. In yet another particular embodiment, the composite backing material layer can have a tensile strength in the machine direction (MD) in a range of about 170 kg/25 mm to about 180 kg/25 mm. In an embodiment, the composite backing material layer can have a tensile strength in the cross direction (CD) of at least about 50 kg/25 mm, such as at least about 60 kg/25 mm, at least about 70 kg/25 mm, at least about 80 kg/25 mm, at least about 90 kg/25 mm, at least about 100 kg/25 mm, at least about 110 kg/25 mm, at least about 120 kg/25 mm, at least about 130 kg/25 mm, at least about 140 kg/25 mm, or even at least about 150 kg/25 mm. In a non-limiting embodiment, the composite backing material layer can have a tensile strength in the cross direction (CD) of not greater than about 150 kg/25 mm, such as not greater than about 140 kg/25 mm, not greater than about 130 kg/25 mm, not greater than about 120 kg/25 mm, not greater than about 110 kg/25 mm, not greater than about 100 kg/25 mm, not greater than about 90 kg/25 mm, not greater than about 80 kg/25 mm, not greater than about 70 kg/25 mm, not greater than about 60 kg/25 mm, or even not greater than about 50 kg/25 mm. It will be appreciated that the composite backing material layer can have a tensile strength in the cross direction (CD) in a range of any two values indicated above. For example, in a particular embodiment, the composite backing material layer can have a tensile strength in the cross direction (CD) in a range of about 75 kg/25 mm to about 85 kg/25 mm. In another particular embodiment, the composite backing material layer can have a tensile strength in the cross direction (CD) in a range of about 100 kg/25 mm to about 110 kg/25 mm. In yet another particular embodiment, the composite backing material layer can have a tensile strength in the cross direction (CD) in a range of about 105 kg/25 mm to about 115 kg/25 mm.

In an embodiment, the composite backing material layer can have a particular flexural strength.

In an embodiment, the composite backing material layer can have a specific or variable flexural modulus. The test for flexural modulus is based on ASTM D-790 and was conducted using Instron 5966 with 10 KN load cell. The samples had a total sample length of 10 cm, a sample width of 1 inch mm, a gauge length of 127 mm, and were tested at a deformation rate of 1 mm/min (flexural grip used: three point bending). For example, the flexural modulus in either the machine direction (MD) or cross direction (CD) can be at least about 5 N/mm², such as at least about 6 N/mm², at least about 7 N/mm², at least about 8 N/mm², at least about 9 N/mm², at least about 10 N/mm², at least about 11 N/mm², at least about 12 N/mm², at least about 15 N/mm², at least about 20 at least about 20 N/mm², at least about 25 N/mm², at least about 30 N/mm², at least about 35 N/mm², or even at least about 40 N/mm². In an embodiment, the flexural modulus can be not greater than about 40 N/mm², such as not greater than about 35 N/mm², not greater than about 30 N/mm², not greater than about 25 N/mm², not greater than about 20 N/mm², not greater than about 15 N/mm², not greater than about 12 N/mm², not greater than about 11 N/mm², not greater than about 10 N/mm², not greater than about 9 N/mm², not greater than about 8 N/mm², not greater than about 7 N/mm², not greater than about 6 N/mm², or even not greater than 5 N/mm². In a non-limiting embodiment, the flexural modulus can be in a range of any maximum or minimum value indicated above.

In an embodiment, the composite backing material layer can include a moisture resistance, defined as the weight percent (wt %) gained or lost of the total weight of the composite backing material layer measured with the following procedures. In a first test, a climatic chamber was set to 10° C. and 25-30% humidity. In a second test, a climatic chamber was set to 35° C. and 80-90% humidity. In a third test, a climatic chamber was set to 45° C. and 30-40% humidity. In all tests, composite backing material layers according to the embodiments described herein are weighed before placed in the climatic chambers for three hours. After three hours in the climatic chambers, the composite backing material layers are removed and weighed for wt % gained or lost. In all tests, the composite backing material layers according to the embodiments described herein was not greater than about 5 wt %, such as not greater than about 4 wt %, not greater than about 3 wt %, not greater than about 2 wt %, not greater than about 1 wt %, or even not greater than 0 wt %.

In another embodiment, the composite backing material layer can include a moisture resistance, defined as the weight percent (wt %) gained or lost of the total weight of the composite backing material layer when submerged in water (H2O) for 1 hour. The moisture resistance can be at least about 1 wt %, such as at least 2 wt %, at least 3 wt %, at least 4 wt %, at least 5 wt %, at least 6 wt %, at least 7 wt %, at least 8 wt %, at least 9 wt %, or at least 10 wt %. In an embodiment, the normal moisture content can be not greater than about 30 wt %, such as not greater than about 20 wt %, not greater than about 15 wt %, such as not greater than 14 wt %, not greater than 13 wt %, not greater than 12 wt %, not greater than 11 wt %, not greater than 10 wt %, not greater than 9 wt %, not greater than 8 wt %, not greater than 7 wt %, not greater than 6 wt %, not greater than 5 wt %, not greater than 4 wt %, or not greater than 3 wt %. In a non-limiting embodiment, the normal moisture content can be in a range of any maximum and minimum value indicated above.

In an embodiment, the composite backing material can have a curl resistance factor “x”, defined by a quotient of a maximum curl of a composite backing material sample divided by a maximum curl of a comparable vulcanized backing material. In an embodiment, the curl resistance factor “x” can be not greater than 1.0, not greater than 0.9, not greater than 0.8, not greater than 0.7, not greater than 0.6, not greater than 0.5, not greater than 0.4, not greater than 0.3, not greater than 0.2, or not greater than 0.1. In an embodiment, the curl resistance factor “x” can be at least 0.1, at least 0.2, at least 0.3, at least 0.4, at least 0.5, at least 0.6, at least 0.7, at least 0.8, at least 0.9 or at least 1.0. In a non-limiting embodiment, the curl resistance factor “x” can be in a range of any maximum or minimum value indicated above.

In an embodiment, the composite backing material can include a combination of layers having a certain weight. For example, the composite backing material can include 100 GMS to 400 GSM of the first flexible backing material, 100 GSM to 350 GSM of the natural fiber material, and 100 GSM to 500 GSM of the second flexible backing material.

### Abrasive Article

In an embodiment, the composite backing material layer can be used to form an abrasive article, such as a coated abrasive article. The abrasive article may further include at least one of a make coat, a size coat, a supersize coat, a back coat, a backsize coat, or any combination thereof.

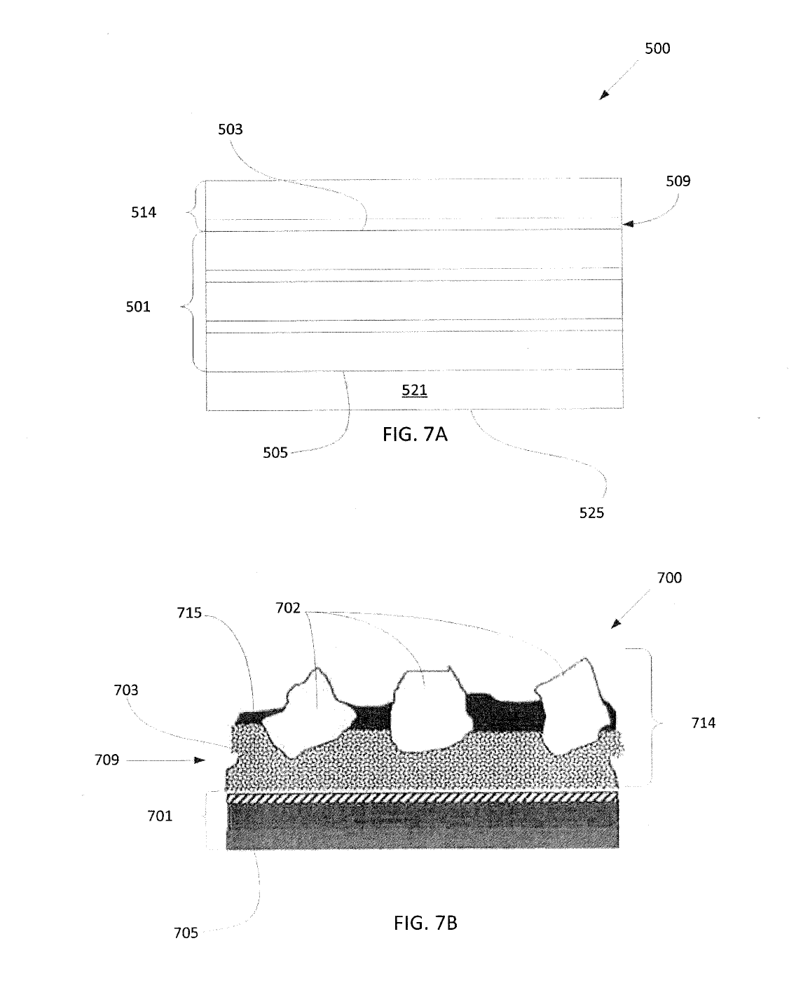

FIG. 7A shows a side view of a coated abrasive article 500 including a composite backing material layer 501 in accordance with embodiments described herein, the composite backing material layer 501 having a first major surface 503 and a second major surface 505. As illustrated, the abrasive article 500 can include an abrasive layer 514 disposed on the first major surface 503 of the composite backing material layer 501. The abrasive layer can comprise multiple layers, including a binder layer 509, also called a make coat. As discussed further herein, a plurality of abrasive grains can be dispersed within, penetrating into, or resting upon the binder layer, or combinations thereof.

FIG. 7B illustrates another embodiment of an abrasive article according to embodiments described herein. FIG. 7B shows a side view of a coated abrasive article 700 including a composite backing material layer 701 in accordance with embodiments described herein, the composite backing material layer 701 having a first major surface 703 and a second major surface 705. In accordance with an embodiment, the first major surface 703 of the composite backing material layer 701 can be the surface on which an abrasive layer 714 is disposed. Further, it will be appreciated that the first major surface 703 of the composite backing material layer 701 can be the surface on which a make coat, a size coat, a supersize coat, or a combination thereof, are disposed.

### Make Coat—Binder

The binder of the make coat or the size coat may be formed of a single polymer or a blend of polymers. For example, the binder may be formed from epoxy, acrylic polymer, or a combination thereof. In addition, the binder may include filler, such as nano-sized filler or a combination of nano-sized filler and micron-sized filler. In a particular embodiment, the binder is a colloidal binder, wherein the formulation that is cured to form the binder is a colloidal suspension including particulate filler. Alternatively, or in addition, the binder may be a nanocomposite binder including sub-micron particulate filler.

The binder generally includes a polymer matrix, which binds abrasive grains to the backing or compliant coat, if present. Typically, the binder is formed of cured binder formulation. In one exemplary embodiment, the binder formulation includes a polymer component and a dispersed phase.

The binder formulation may include one or more reaction constituents or polymer constituents for the preparation of a polymer. A polymer constituent may include a monomeric molecule, a polymeric molecule, or a combination thereof. The binder formulation may further comprise components selected from the group consisting of solvents, plasticizers, chain transfer agents, catalysts, stabilizers, dispersants, curing agents, reaction mediators and agents for influencing the fluidity of the dispersion.

The polymer constituents can form thermoplastics or thermosets. By way of example, the polymer constituents may include monomers and resins for the formation of polyurethane, polyurea, polymerized epoxy, polyester, polyimide, polysiloxanes (silicones), polymerized alkyd, styrene-butadiene rubber, acrylonitrile-butadiene rubber, polybutadiene, or, in general, reactive resins for the production of thermoset polymers. Another example includes an acrylate or a methacrylate polymer constituent. The precursor polymer constituents are typically curable organic material (i.e., a polymer monomer or material capable of polymerizing or crosslinking upon exposure to heat or other sources of energy, such as electron beam, ultraviolet light, visible light, etc., or with time upon the addition of a chemical catalyst, moisture, or other agent which cause the polymer to cure or polymerize). A precursor polymer constituent example includes a reactive constituent for the formation of an amino polymer or an aminoplast polymer, such as alkylated urea-formaldehyde polymer, melamine-formaldehyde polymer, and alkylated benzoguanamine-formaldehyde polymer; acrylate polymer including acrylate and methacrylate polymer, alkyl acrylate, acrylated epoxy, acrylated urethane, acrylated polyester, acrylated polyether, vinyl ether, acrylated oil, or acrylated silicone; alkyd polymer such as urethane alkyd polymer; polyester polymer; reactive urethane polymer; phenolic polymer such as resole and novolac polymer; phenolic/latex polymer; epoxy polymer such as bisphenol epoxy polymer; isocyanate; isocyanurate; polysiloxane polymer including alkylalkoxysilane polymer; or reactive vinyl polymer. The binder formulation may include a monomer, an oligomer, a polymer, or a combination thereof. In a particular embodiment, the binder formulation includes monomers of at least two types of polymers that when cured may crosslink. For example, the binder formulation may include epoxy constituents and acrylic constituents that when cured form an epoxy/acrylic polymer.

### Additives—Grinding Aid

The abrasive layer may further include a grinding aid to increase the grinding efficiency and cut rate. A useful grinding aid can be inorganic based, such as a halide salt, for example, sodium cryolite, and potassium tetrafluoroborate; or organic based, such as a chlorinated wax, for example, polyvinyl chloride. A particular embodiment includes cryolite and potassium tetrafluoroborate with particle size ranging from 1 micron to 80 microns, and most typically from 5 microns to 30 microns. The supersize coat can be a polymer layer applied over the abrasive grains to provide anti-glazing and anti-loading properties.

### Back Coat—Compliant Coat

The coated abrasive article may optionally include compliant and back coats (not shown). These coats may function as described above and may be formed of binder compositions.

### Abrasive Layer

As illustrated in FIG. 7B in particular, the abrasive article 700 can include an abrasive layer 714 disposed on the first major surface 703 of the composite backing material layer 701. The abrasive layer 714 can comprise multiple layers, including a binder layer 709, also called a make coat. In particular embodiments, the abrasive layer 714 can comprise abrasive particles or grains.

### Abrasive Grains

In a particular embodiment, as illustrated in FIG. 7B, abrasive grains 702 are penetrating into the binder layer (make layer) 709. A size coat 715 can optionally be disposed on the binder layer 709. A supersize coat (not shown) can optionally be disposed over the size coat 715. A back coat (not shown) can be disposed on the second major surface 705 (i.e., the non-abrasive side) of the composite backing material layer 701. A fastener layer (not shown) can be disposed over the back coat, or alternatively can be directly disposed onto the second major side 705 of the composite backing material layer 701. In a particular embodiment, the coated abrasive article 700 can optionally be attached to a back-up pad (not shown) or a vacuum system (not shown).

The abrasive layer can include a layer of binder composition and abrasive particles. The abrasive layer can include a make coat, an abrasive slurry, or a combination thereof. In an embodiment including a make coat, the abrasive particles can be disposed on the binder composition. In an embodiment including an abrasive slurry, the abrasive particles can be dispersed within the binder composition. It will be appreciated that a plurality of abrasive grains can be dispersed within, penetrating into, or resting upon the binder layer, or combinations thereof.

The abrasive grains can include essentially single phase inorganic materials, such as alumina, silicon carbide, silica, ceria, and harder, high performance superabrasive grains such as cubic boron nitride and diamond. Additionally, the abrasive grains can include composite particulate materials. Such materials can include aggregates, which can be formed through slurry processing pathways that include removal of the liquid carrier through volatilization or evaporation, leaving behind green aggregates, optionally followed by high temperature treatment (i.e., firing) to form usable, fired aggregates. Further, the abrasive regions can include engineered abrasives including macrostructures and particular three-dimensional structures.

In an exemplary embodiment, the abrasive grains are blended with the binder formulation to form abrasive slurry. FIG. 7A illustrates abrasive layer 514 comprising an abrasive slurry in which abrasive particles or grains can be dispersed within. Alternatively, the abrasive grains are applied over the binder formulation after the binder formulation is coated on the backing. Optionally, a functional powder may be applied over the abrasive regions to prevent the abrasive regions from sticking to a patterning tooling. Alternatively, patterns may be formed in the abrasive regions absent the functional powder.

The abrasive grains may be formed of any one of or a combination of abrasive grains, including silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive grains may be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, and a blend thereof. Particular embodiments have been created by use of dense abrasive grains comprised principally of alpha-alumina.

The abrasive grain may also have a particular shape. An example of such a shape includes a rod, a triangle, a pyramid, a cone, a solid sphere, a hollow sphere, or the like. Alternatively, the abrasive grain may be randomly shaped.

In an embodiment, the abrasive grains can have an average grain size not greater than 1500 microns, such as not greater than about 1000 microns, not greater than 500 microns, not greater than 200 microns, or not greater than 100 microns. In another embodiment, the abrasive grain size is at least 50 microns, at least 100 microns, at least 200 microns, at least 500 microns, or even at least 1000 microns. It will be appreciated that the abrasive grains can have an average grain size within a range of any maximum or minimum value described herein. For example, in a particular embodiment, the abrasive grains size is from about 50 microns to about 1500 microns. The grain size of the abrasive grains is typically specified to be the longest dimension of the abrasive grain. Generally, there is a range distribution of grain sizes. In some instances, the grain size distribution is tightly controlled.

### Method of Making—Coated Abrasive Article

An abrasive article according to embodiments herein can be formed by any method known in the art. For example a method of forming an abrasive article with the composite backing material can include disposing an abrasive layer on a composite backing material according to any embodiment herein. The abrasive layer may be formed from one or more coats and a plurality of abrasive grains. For example, the abrasive layer can include a make coat and can optionally include a size coat or a supersize coat. Abrasive layers generally include abrasive grains disposed on, embedded within, dispersed within, or combinations thereof, in a binder.

In accordance with an embodiment for making a coated abrasive article having a composite backing material layer according to embodiments described herein, a backing can be distributed from a roll, the backing can be coated with a binder formulation dispensed from a coating apparatus. An exemplary coating apparatus includes a drop die coater, a knife coater, a curtain coater, a vacuum die coater or a die coater. Coating methodologies can include either contact or non-contact methods. Such methods include two roll, three roll reverse, knife over roll, slot die, gravure, rotary printing, extrusion, spray coating applications, or combinations thereof.

In an embodiment, the binder formulation can be provided in a slurry including the formulation and abrasive grains. In an alternative embodiment, the binder formulation can be dispensed separate from the abrasive grains. The abrasive grains may be provided following coating of the backing with the binder, after partial curing of the binder formulation, after patterning of the binder formulation, if any, or after fully curing the binder formulation. The abrasive grains may, for example, be applied by a technique, such as electrostatic coating, drop coating, or mechanical projection.

In another embodiment, the backing, coated with the binder and abrasive grains, can be stamped, die-cut, laser cut, or combinations thereof to form the shape of the coated abrasive (e.g., round disc) or a pattern of apertures, if any, that are cut through the coated abrasive.

In another embodiment, the composite backing can be first cut into discs and then coated with binder, abrasive and size coat.

In another embodiment, the backing can be selectively coated with the binder to leave uncoated regions that are then coated with abrasive grains to form the abrasive areas. For example, the binder can be printed onto the backing, such as by screen printing, offset printing, rotary printing, or flexographic printing. In another example, the binder can be selectively coated using gravure coating, slot die coating, masked spray coating, or the like. Alternatively, a photoresist or UV curable mask can be applied to the backing and developed, such as by photolithography, to mask portions of the backing. In another example, a dewetting compound can be applied to the backing prior to applying the binder.

### Characteristics—Coated Abrasive Article

In an embodiment, an abrasive article can have a tensile strength For example, the tensile strength in the machine direction (MD) can be at least 50 Kg/25 mm, such as at least 50 Kg/25 mm, at least 75 Kg/25 mm, at least 100 Kg/25 mm, at least 125 Kg/25 mm, at least 150 Kg/25 mm, at least 175 Kg/25 mm, at least 200 Kg/25 mm, at least 225 Kg/25 mm, or at least 250 Kg/25 mm. In an embodiment, the tensile strength in the machine direction (MD) can be not greater than 250 Kg/25 mm, such as not greater than 225 Kg/25 mm, not greater than 200 Kg/25 mm, not greater than 175 Kg/25 mm, not greater than 150 Kg/25 mm, not greater than 125 Kg/25 mm, not greater tan 100 Kg/25 mm, not greater than 75 Kg/25 mm, not greater than 50 Kg/25 mm, or not greater than 25 Kg/25 mm. In an embodiment, the tensile strength in the cross direction (CD) can be at least 50 Kg/25 mm, such as at least 75 Kg/25 mm, at least 100 Kg/25 mm, or at least 120 Kg/25 mm. In an embodiment the tensile strength in the cross direction (CD) can be not greater than 120 Kg/25 mm, such as not greater than 100 Kg/25 mm, not greater than 75 Kg/25 mm, or not greater than 50 Kg/25 mm. It will be understood that the tensile strength in either the machine direction (MD) or the cross direction (CD) can be in a range of any maximum or minimum value indicated above.

In an embodiment, the abrasive article can have a flexural modulus. For example, the flexural modulus of the abrasive article can be at least 5 N/mm2, such as at least 10 N/mm2, at least 15 N/mm2, at least 20 N/mm2, at least 25 N/mm2, at least 30 N/mm2, at least 35 N/mm2, or at least 40 N/mm2. In an embodiment, the flexural modulus of the abrasive article can be not greater than 40 N/mm2, such as not greater than 35 N/mm2, not greater than 30 N/mm2, not greater than 25 N/mm2, not greater than 20 N/mm2, not greater than N/mm2, not greater than 10 N/mm2, or not greater than 5 N/mm2. It will be understood that the abrasive article can have a flexural modulus in a range of any maximum or minimum value indicated above.

In an embodiment, the abrasive article can have a teak wood total cut performance. For example, the teak wood total cut performance can be at least [x] and not greater than [y].

In an embodiment, the abrasive article can have a grind performance ratio (total cut/total weight loss). For example, the grind performance ratio can be at least [x] and not greater than [y].

The Examples below illustrate the aforementioned improvements.

### Example 1

### Composite Backing Samples

Composite backing materials were constructed as described in table 1:

TABLE 1

| | 1^{st} Flexible | 1^{st} | Natural | 2^{nd} | 2^{nd} Flexible |
|---|---|---|---|---|---|
| | backing | Adhesive | Fiber | Adhesive | backing |
| Sample | material | Layer | Layer | Layer | material |
| A | Polymer film¹ | Epoxy³ | Jute⁴ | Epoxy³ | Woven⁵ |
| B | Polymer film¹ | Epoxy³ | Jute⁴ | Epoxy³ | Woven⁶ |
| C | Polymer film¹ | Epoxy³ | Jute⁴ | Epoxy³ | Woven⁷ |
| D | Polymer film¹ | Epoxy³ | Jute⁴ | Epoxy³ | Paper⁸ |
| E | Non-woven² | Epoxy³ | Jute⁴ | Epoxy³ | Woven⁵ |
| F | Non-woven² | Epoxy³ | Jute⁴ | Epoxy³ | Woven⁶ |
| G | Non-woven² | Epoxy³ | Jute⁴ | Epoxy³ | Woven⁷ |
| H | Non-woven² | Epoxy³ | Jute⁴ | Epoxy³ | Paper⁸ |

¹Polyvinylchloride (PVC) film, approximate thickness 0.45 mm
²Spunlace cotton, approximate weight 150_ g/m²
³Brand: Araldite
⁴weight 225 g/m²
⁵unfinished polycotton blend, weight 250 g/m²
⁶unfinished polyester, weight 250 g/m²
⁷finished cotton blend, weight 250 g/m²
⁸paper, 350 GSM obtained internally from Gypsum

The first adhesive layer was applied to the first flexible backing material and then partially cured. The natural fiber layer was then applied to the partially cured first adhesive layer to form an intermediate laminate. The second adhesive layer was applied to the second flexible backing material and then partially cured. The intermediate laminate was applied to the partially cured second adhesive layer and the entire laminate structure was then fully cured to form the completed composite material backing.

### Example 2

### Mechanical Properties Testing

Mechanical properties testing of composite backing material samples as well as comparative samples of conventional vulcanized fiber backing material was conducted. Tensile strength testing was conducted using an Instron 5982 with a 2 kN load cell. The samples had a total sample length of 200 mm, a sample width of 25 mm, a gauge length of 127 mm, and were tested at a deformation rate of 300 mm/min. The tensile strength testing results are shown in FIG. 9 and in Table 2 below.

TABLE 2

| | M/D | C/D |
|---|---|---|
| | (Kg/25 mm) | (Kg/25 mm) |
| 0.8 mm VF | 165 | 115 |
| Design E | 172 | 108 |
| Design C | 117 | 105 |
| Design A | 154 | 79 |

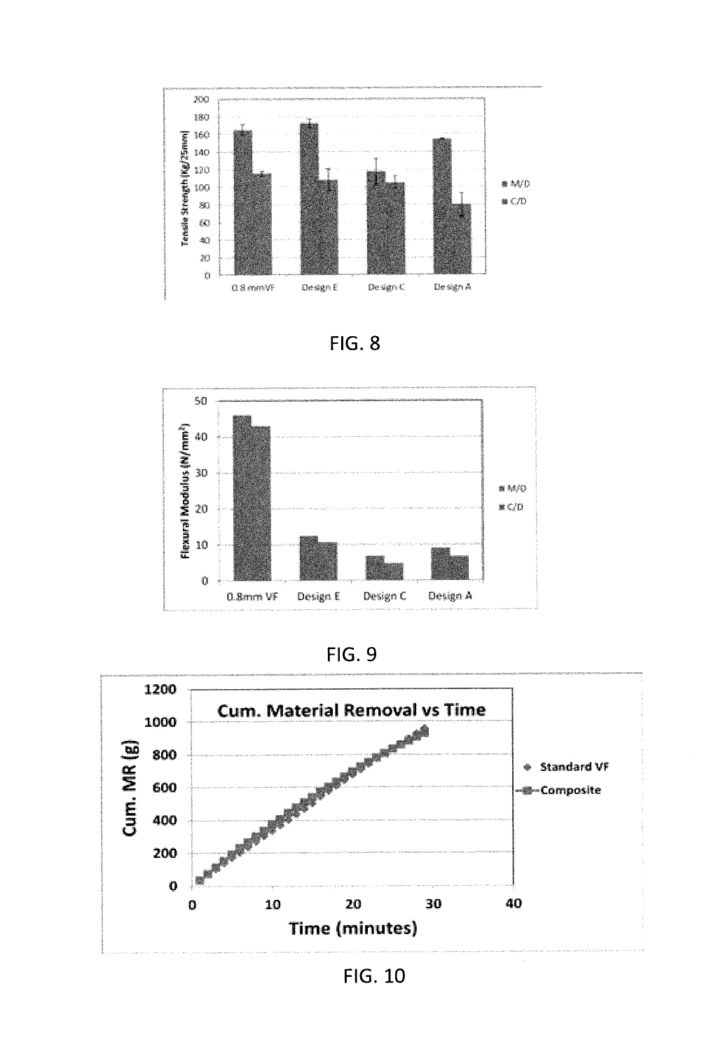

As shown in FIG. 8 and Table 2, the tensile strength in the machine direction (M/D) of composite backing material sample A is similar to, but slightly lower than, a comparative sample of 0.8 mm vulcanized fiber. The tensile strength in the machine direction of composite backing material sample C is moderately lower than, the comparative sample of 0.8 mm vulcanized fiber. The tensile strength in the machine direction of composite backing material sample E is similar to, and in fact slightly higher than, the comparative sample of 0.8 mm vulcanized fiber.

As shown in FIG. 8 and Table 2, the tensile strength in the cross direction (C/D) of composite backing material sample A is moderately lower than the comparative sample of 0.8 mm vulcanized fiber. The tensile strength in the cross direction of composite backing material sample C is greater than sample A, and comparable to but slightly lower than the comparative sample of 0.8 mm vulcanized fiber. The tensile strength in the cross direction of composite backing material sample E is slightly higher than sample C and is also and comparable to but slightly lower than the comparative sample of 0.8 mm vulcanized fiber.

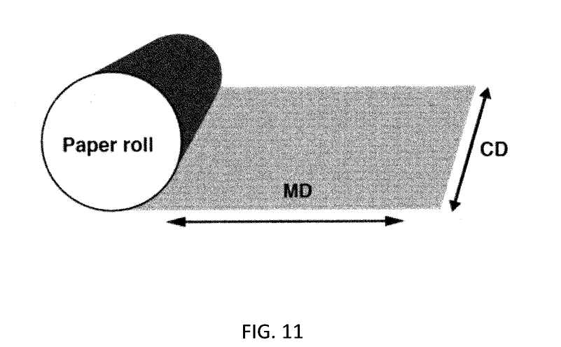

Flexural modulus testing was conducted using an Instron 5966 with a 10 KN load cell. The samples had a total sample length of 10 cm, a sample width of 1 inch mm, a gauge length of 127 mm, and were tested at a deformation rate of 1 mm/min (flexural grip used: three point bending) based on ASTM D-790. The results of the flexural modulus testing are shown in FIG. 11. Please use this figure and the raw data below for reference.

TABLE 3

| | M/D | C/D |
|---|---|---|
| Material | (N/mm²) | (N/mm²) |
| 0.8 mm VF | 52.23 | 47.5 |
| Design E | 12.39 | 10.65 |
| Design C | 6.84 | 4.73 |
| Design A | 8.99 | 6.73 |

As shown in FIG. 9 and Table 3, all samples of the composite backing material are significantly more flexible than a comparative 0.8. mm vulcanized fiber material. Composite material samples A, C, and E all have a flexural modulus that is significantly lower (less than 25% of) the flexural modulus of the 0.8 mm vulcanized fiber material.

### Example 3

### Abrasive Performance Testing

Abrasive performance testing of coated abrasive articles that include composite backing material samples as well as comparative coated abrasives that vulcanized fiber backing material was conducted. The inventive and comparative coated abrasive samples were used to abrade teak wood and babul wood test panels according to the following method.

Untreated wood panels were abraded using a hand-held angle grinder (Make BOSCH, Model) equipped with an abrasive disc, a back-up pad, and optionally, a vacuum attachment. One inventive sample (5-inch abrasive disc), which includes the composite material backing Sample C, and one comparative sample (5-inch abrasive disc), which includes 0.8 mm vulcanized fiber backing were tested. The inventive and comparative abrasive discs were the same in all respects except for the backing materials. The abrasive grit was aluminum oxide grit size 80.

For all testing, the wood panels were abraded using a side to side and/or reciprocatory motion across the surface of the panel in a manner intended to reflect the conditions commonly observed in the field where such discs are used. A single abrasive disc was used to provide controlled abrasion over the wood panel until 30 minutes expired or the end of life of the disc was reached. The results obtained are shown in FIG. 10.

As shown in FIG. 10, the inventive coated abrasive disc provided comparable or better abrasive performance for babul wood grinding compared to vulcanized fiber abrasive disc over a 30 minute time span. The cumulative material removal for the inventive sample is about 540 grams in 15 minutes compared to about 500 grams for the comparative sample.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25.

As used herein, the phrase “average particle diameter” can be reference to an average, mean, or median particle diameter, also commonly referred to in the art as D50.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and can be found in textbooks and other sources within the scintillation and radiation detection arts.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity can not be required, and that one or more further activities can be performed in addition to those described. Still further, the order in which activities are listed is not necessarily the order in which they are performed.

The disclosure is submitted with the understanding that it will not be used to interpret or limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter can be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

Item 1. A composite material comprising: a first flexible backing material layer; and a natural fiber layer; wherein the natural fiber layer is disposed on the first flexible backing material layer.

Item 2. A composite backing material comprising: a composite material according to claim 1; and a second flexible backing material layer, wherein the second flexible backing material layer is disposed on the natural fiber layer according to claim 1.

Item 3. A composite backing material comprising: a composite material according to claim 1; and a second natural fiber layer, wherein the second natural fiber layer is disposed on the first flexible backing material layer opposite the first natural fiber layer according to claim 1.

Item 4. A composite backing material comprising: a first flexible backing material layer; a natural fiber layer; and a second flexible backing material layer, wherein the natural fiber layer is disposed on the first flexible backing material layer and the second backing material layer is disposed on the natural fiber layer.

Item 5. A composite backing material comprising: a first natural fiber layer; a flexible backing material layer; and a second natural fiber layer, wherein the flexible backing material layer is disposed on the first natural fiber layer and the second natural fiber layer is disposed on the flexible backing material layer.

Item 6. The composite backing material of claim 1, claim 2, claim 3, or claim 4, further comprising an adhesive layer disposed between the first flexible backing material layer and the natural fiber layer.

Item 7. The composite backing material of claim 2 or claim 4, further comprising an adhesive layer disposed between the second flexible backing material layer and the natural fiber layer.

Item 8. The composite backing material of claim 5, further comprising an adhesive layer disposed between the first natural fiber layer and the flexible backing material layer.

Item 9. The composite backing material of claim 5, further comprising an adhesive layer disposed between the flexible backing material layer and the second natural fiber layer.

Item 10. A method of making a composite backing material comprising: providing a first flexible backing material layer; disposing a layer of adhesive material on the first flexible backing material to form an adhesive coated first flexible backing material; disposing a natural fiber layer on the layer of adhesive coated first flexible backing material; disposing a layer of an adhesive material on the natural fiber layer to form an adhesive coated natural fiber layer; disposing a second flexible backing material layer on the adhesive coated natural fiber layer.

Item 11. The method of claim 10, wherein the adhesive coated first flexible backing material is at least partially cured prior to disposing the natural fiber layer.

Item 12. The method of claim 10, wherein the adhesive coated natural fiber layer is at least partially cured prior to disposing the second flexible backing material layer.

Item 13. A method of making a composite backing material comprising: providing a first natural fiber layer; disposing a layer of an adhesive material on the first natural fiber layer to form an adhesive coated first natural fiber layer; disposing a flexible backing material layer on the adhesive coated first natural fiber layer; disposing a layer of an adhesive material on the flexible backing material layer to form an adhesive coated flexible backing material; and disposing a second natural fiber layer on the adhesive coated flexible backing material.

Item 14. An abrasive article comprising: a composite backing material according to claim 2, or claim 3, or claim 4, or claim 5; and an abrasive layer disposed on the composite backing material.

Item 15. The abrasive article of claim 14, further comprising at least one of a size coat or a supersize coat.

Item 16. The abrasive article of claim 14, further comprising a back coat.

Item 17. A method of making a coated abrasive article comprising: disposing an abrasive layer on a composite backing material according to claim 2, or claim 3, or claim 4, or claim 5.

Item 18. The composite backing material of claim 1, or claim 2, or claim 3, or claim 4, wherein the first flexible backing material layer comprises a polymer film, a non-woven fabric, or a combination thereof.

Item 19. The composite backing material of claim 18, wherein the polymer film comprises a thermoplastic polymer or a thermoset polymer.

Item 20. The composite backing material of claim 19, wherein the thermoplastic polymer comprises polyethylene, polyvinyl chloride, or combinations thereof.

Item 21. The composite backing material of claim 19, wherein the thermoset polymer comprises a phenolic film.

Item 22. The composite backing material of claim 21, wherein the phenolic film comprises a novolac film.

Item 23. The composite backing material of claim 18, wherein the non-woven fabric comprises polyester fiber, cotton fiber, or a combination thereof.

Item 24. The composite backing material of claim 18, wherein the non-woven fabric comprises a spunlace fabric.

Item 25. The composite backing material of claim 18, wherein the non-woven fabric has an areal density of at least 50 GSM and not greater than 300 GSM.

Item 26. The composite backing material of claim 5, wherein the flexible backing material layer comprises a polymer film, a non-woven fabric, a woven fabric, paper, vulcanized fiber, or a combination thereof.

Item 27. The composite backing material of claim 1, or claim 2, or claim 4, wherein the natural fiber layer comprises at least one natural fiber selected from the group consisting of jute, hemp, cotton, coir, and combinations thereof.

Item 28. The composite backing material of claim 5, wherein the first natural fiber layer comprises at least one natural fiber selected from the group consisting of jute, hemp, cotton, coir, and combinations thereof.

Item 29. The composite backing material of claim 5, wherein the second natural fiber layer comprises at least one natural fiber selected from the group consisting of jute, hemp, cotton, coir, and combinations thereof.

Item 30. The composite backing material of claim 1, or claim 2, or claim 3, or claim 4, wherein the natural fiber layer comprises a natural fiber, a synthetic fiber, or a mixture thereof.

Item 31. The composite backing material of claim 5, wherein the first natural fiber layer or the second natural fiber layer comprises a natural fiber, a synthetic fiber, or a mixture thereof.

Item 32. The composite backing material of claim 25 or claim 26, wherein the mixture has at least 60-80% of natural fiber.

Item 33. The composite backing material of claim 25 or claim 26, wherein the mixture has at least 20-40% of synthetic fiber.

Item 34. The composite backing material of claim 1, or claim 2, or claim 3, or claim 4 wherein the natural fiber layer comprises a fabric having an areal density of at least 100 grams per square meter (GSM) and not greater than 350 GSM.

Item 35. The composite backing material of claim 1, or claim 2, or claim 3, or claim 4, wherein the natural fiber layer comprises a woven fabric or a non-woven fabric.

Item 36. The composite backing material of claim 30, wherein the natural fiber layer is a woven fabric.

Item 37. The composite backing material of claim 31, wherein the natural fiber layer has at least 5 and not greater than 20 yarns in the warp direction.

Item 38. The composite backing material of claim 31, wherein the natural fiber layer has at least 5 and not greater than 20 yarns in the weft direction.

Item 39. The composite backing material of claim 31, wherein the natural fiber layer has a Warp count of at least 1 and not greater than 10.

Item 40. The composite backing material of claim 31, wherein the natural fiber layer has a Weft count of at least 1 and not greater than 10.

Item 41. The composite backing material of claim 1, or claim 2, or claim 3, or claim 4, wherein the natural fiber layer has a tensile strength in the cross-direction (C/D) of at least 5 kg/25 mm and not greater than 35 kg/25 mm.

Item 42. The composite backing material of claim 1, or claim 2, or claim 3, or claim 4, wherein the natural fiber layer has a tensile strength in the machine-direction (M/D) of at least 5 kg/25 mm and not greater than 35 kg/25 mm.

Item 43. The composite backing material of claim 2 or claim 4, wherein the second flexible backing material layer comprises woven fabric, paper, vulcanized fiber, or a combination thereof.

Item 44. The composite backing material of claim 2 or claim 4, wherein the second flexible backing material layer has an areal density of at least 100 GSM and not greater than 500 GSM.

Item 45. The composite backing material of claim 2 or claim 4, wherein the second flexible backing material layer has a tensile strength in the cross-direction (C/D) of at least 25 Kg/25 mm and not greater than 100 Kg/25 mm.

Item 46. The composite backing material of claim 2 or claim 4, wherein the second flexible backing material layer has a tensile strength in the machine-direction (M/D) of at least 25 Kg/25 mm and not greater than 100 Kg/25 mm.

Item 47. The composite backing material of claim 38, wherein the second flexible backing material layer comprises a woven fabric.

Item 48. The composite backing material of claim 42, wherein the woven fabric comprises polyester fabric, cotton fabric, polycotton fabric, or a combination thereof.

Item 49. The composite backing material of claim 38, wherein the second flexible backing material layer comprises vulcanized fiber having a thickness of 0.1 mm-0.5 mm.

Item 50. The composite backing material of claim 6, or claim 7, or claim 8, or claim 9 wherein the adhesive layer comprises an epoxy adhesive, an acrylic adhesive, a latex adhesive, a polyvinyl acetate adhesive, a silicone adhesive, a polyimide adhesive, a polyurethane adhesive, or combinations thereof.

Item 51. The composite backing material of claim 45, wherein the adhesive layer comprises an epoxy resin.

Item 52. The composite backing material of claim 2 or claim 4, wherein the composite backing material has a stiffness in the cross-direction (C/D) of at least 900 MPa and not greater than 1800 MPa.

Item 53. The composite backing material of claim 2 or claim 4, wherein the composite backing material has a stiffness in the machine direction (M/D) of at least 1200 MPa and not greater than 2000 MPa.

Item 54. The composite backing material of claim 2 or claim 4, wherein the composite backing material has a flexural modulus of at least 5 N/mm² and not greater than 40 N/mm².

Item 55. The composite backing material of claim 2 or claim 4, wherein the composite backing material has a tensile strength in the cross-direction (C/D) of at least 50 Kg/25 mm and not greater than 150 Kg/25 mm.

Item 56. The composite backing material of claim 2 or claim 4, wherein the composite backing material has a tensile strength in the machine-direction (M/D) of at least 100 Kg/25 mm and not greater than 200 Kg/25 mm.

Item 57. The composite backing material of claim 2 or claim 4, wherein the composite has a total thickness in a range of 0.5 to 5 mm.

Item 58. The composite backing material of claim 2 or claim 4, wherein the composite backing material has a moisture (H₂O) resistance weight loss or weight gain of less than 5 wt %.

Item 59. The composite backing material of claim 2 or claim 4, wherein the composite backing material has a curl resistance factor of not greater than 1.0.

Item 60. The abrasive article of claim 14, wherein the abrasive layer comprises a layer of binder composition and abrasive particles, the abrasive particles being disposed on the binder composition or dispersed within the binder composition.

Item 61. The abrasive article of claim 14, wherein the abrasive article has a tensile strength in the cross-direction of at least 50 Kg/25 mm and not greater than 120 Kg/25 mm.

Item 62. The abrasive article of claim 14, wherein the abrasive article has a tensile strength in the Machine direction of at least 50 Kg/25 mm and not greater than 250 Kg/25 mm.

Item 63. The abrasive article of claim 14, wherein the abrasive article has a flexural modulus of at least 5 N/mm² and not greater than 40 N/mm2.

What is claimed is:

1. A composite material comprising:
a first flexible backing material layer; and
a natural fiber layer;
wherein the natural fiber layer is disposed on the first flexible backing material layer.

2. A composite backing material comprising:
a composite material according to claim 1; and
a second flexible backing material layer,
wherein the second flexible backing material layer is disposed on the natural fiber layer according to claim 1.

3. A composite backing material comprising:
a composite material according to claim 1; and
a second natural fiber layer,
wherein the second natural fiber layer is disposed on the first flexible backing material layer opposite the first natural fiber layer according to claim 1.

4. The composite backing material of claim 1, further comprising an adhesive layer disposed between the first flexible backing material layer and the natural fiber layer.

5. The composite backing material of claim 2, further comprising an adhesive layer disposed between the second flexible backing material layer and the natural fiber layer.

6. A method of making a composite backing material comprising:
providing a first flexible backing material layer;
disposing a layer of adhesive material on the first flexible backing material to form an adhesive coated first flexible backing material;
disposing a natural fiber layer on the layer of adhesive coated first flexible backing material;
disposing a layer of an adhesive material on the natural fiber layer to form an adhesive coated natural fiber layer;
disposing a second flexible backing material layer on the adhesive coated natural fiber layer.

7. An abrasive article comprising:
a composite backing material according to claim 2; and
an abrasive layer disposed on the composite backing material.

8. The composite backing material of claim 1, wherein the first flexible backing material layer comprises a polymer film, a non-woven fabric, or a combination thereof.

9. The composite backing material of claim 8, wherein the polymer film comprises polyethylene, polyvinyl chloride, or combinations thereof.

10. The composite backing material of claim 8, wherein the polymer film comprises a novolac film.

11. The composite backing material of claim 8, wherein the non-woven fabric comprises a spunlace fabric.

12. The composite backing material of claim 8, wherein the non-woven fabric has an areal density of at least 50 GSM and not greater than 300 GSM.

13. The composite backing material of claim 1, wherein the natural fiber layer comprises at least one natural fiber selected from the group consisting of jute, hemp, cotton, coir, and combinations thereof.

14. The composite backing material of claim 3, wherein the second natural fiber layer comprises at least one natural fiber selected from the group consisting of jute, hemp, cotton, coir, and combinations thereof.

15. The composite backing material of claim 1, wherein the natural fiber layer comprises a fabric having an areal density of at least 100 grams per square meter (GSM) and not greater than 350 GSM.

16. The composite backing material of claim 1, wherein the natural fiber layer has a tensile strength in the cross-direction (C/D) of at least 5 kg/25 mm and not greater than 35 kg/25 mm and a tensile strength in the machine-direction (M/D) of at least 5 kg/25 mm and not greater than 35 kg/25 mm.

17. The composite backing material of claim 2, wherein the second flexible backing material layer comprises woven fabric, paper, vulcanized fiber, or a combination thereof.

18. The composite backing material of claim 2, wherein the second flexible backing material layer has an areal density of at least 100 GSM and not greater than 500 GSM.

19. The composite backing material of claim 4, wherein the composite backing material has a stiffness in the cross-direction (C/D) of at least 900 MPa and not greater than 1800 MPa and a stiffness in the machine direction (M/D) of at least 1200 MPa and not greater than 2000 MPa.

20. The abrasive article of claim 14, wherein the abrasive article has a tensile strength in the cross-direction of at least 50 Kg/25 mm and not greater than 120 Kg/25 mm and a tensile strength in the Machine direction of at least 50 Kg/25 mm and not greater than 250 Kg/25 mm.
